(19) United States
(12) Patent Application Publication
(10) Pub. No.: US 2023/0074961 A1
(43) Pub. Date: Mar. 9, 2023

(54) MULTISCALE-POROUS ANION EXCHANGE MEMBRANE, MANUFACTURE OF THE SAME

(71) Applicant: POSTECH Research and Business Development Foundation, Pohang-si (KR)

(72) Inventors: Geunbae LIM, Gyeongju-si (KR); Hyukjin J. KWON, Yongin-si (KR); Minsoo LEE, Incheon (KR)

(21) Appl. No.: 17/940,922

(22) Filed: Sep. 8, 2022

(30) Foreign Application Priority Data
Sep. 9, 2021 (KR) 10-2021-0120551

(51) Int. Cl. C25B 13/02; C25B 13/08

(52) U.S. Cl. CPC C25B 13/02; C25B 13/08

(57) ABSTRACT

Provided is a porous anion exchange membrane including a porous polymer support; and an anion-permselective material supported in the porous polymer support, in which the porous anion exchange membrane has a micro-nano composite pore structure including microscale pores and nanoscale pores.

### CROSS-REFERENCE TO RELATED APPLICATION

This application claims priority to and the benefit of Korean Patent Application No. 10-2021-01 20551 filed in the Korean Intellectual Property Office on Sep. 9, 2021, Korean Patent Application No. filed in the Korean Intellectual Property Office on, and Korean Patent Application No. 10-2022-0114311 filed in the Korean Intellectual Property Office on Sep. 8, 2022, the entire contents of which are incorporated herein by reference.

### BACKGROUND OF THE INVENTION

### (a) Field of the Invention

The present invention relates to a porous anion exchange membrane for treating a positively charged sample and a manufacturing method of the same.

More specifically, the present invention relates to a porous anion exchange membrane including a porous polymer support and microscale pores and nanoscale pores supporting an anion-permselective material in the polymer support and a manufacturing method of the same.

### (b) Description of the Related Art

Electrokinetics is a generic term for physical and electrochemical phenomena that occur in a fluid containing various types of particles, and ion concentration polarization (ICP) generated on an interface between a nanochannel/ion exchange membrane and a microchannel (bulk fluid) as a representative electrokinetics phenomenon has an advantage of being able to pre-process a sample through an intuitive and simple mechanism.

Due to such an advantage, application research into specific fields, such as detection and diagnosis of trace amount target samples, and continuous classification of target samples, has been steadily conducted.

Electrokinetics-based sample concentration may be performed in a complex channel structure in which microchannels and nanochannels are mixed.

When an electric field is applied to both ends (the right end of an upper channel/the left end of a lower channel) of the two microchannels connected by the nanochannel, an ion depletion region is induced in the upper channel and an ion concentration region is induced in the lower channel.

In this case, the upper channel in which the ion depletion region is formed serves as a main channel, and the lower channel serves as an electrode buffer channel.

When a fluid flow is applied to the main channel from the right side (positive potential applying unit) to the left side, the drag force and the electric force of the fluid act in opposite directions to opposite charged particles in the fluid reaching the ion depletion region.

As a result, the particles stop at a point where the magnitudes of velocity components by the two forces are the same as each other, and a concentration region (concentration band) is formed at the corresponding point.

The formed position of the concentration region is generally near the outer interface of the ion depletion region, and a distribution difference occurs depending on an electrical property (electrophoretic mobility) of the particles under the same system operating conditions (voltage and flow rate).

For electrokinetic treatment (concentration, separation, etc.) of positively charged samples (ions, inorganic particles, organic particles, etc.), an anion-permselective material needs to be located in the fluid channel to induce a concentrated electric field region throughout the channel.

At this time, the flow of the fluid needs to exist in a direction parallel to the direction of the electric field formed in the concentrated electric field region.

A commercial anion exchange membrane, the most easily available anion-permselective material, is not compatible with a treatment device.

The reason thereof is as follows.

Since pores of a micrometer scale or more are not contained (containing only nanometer-scale pores), the fluid flow in a normal direction through the membrane cannot be allowed.

In addition, since the size and the shape are standardized, flexible application to the system is difficult.

Therefore, in order to manufacture a current treatment device, an anion-permselective material capable of overcoming these limitations is inevitably required.

A negatively charged sample treatment device is implemented simply due to the presence of Nafion, a commercially available cation exchange material (Nafion patterning technique).

However, in the case of a positively charged sample treatment device, since there is no commercially easily available anion-permselective material such as Nafion, it is inconvenient to go through a very complicated manufacturing/synthesis process of the anion-permselective material to implement the device.

For this reason, unlike a negatively charged sample treatment field, which is currently actively researched, the related research is very slow in the positively charged sample treatment field.

There is a method of combining lithography and surface modification as a method of manufacturing the positively charged sample treatment device.

After forming a nanochannel through a general photolithography process, an anion exchange membrane (channel) is implemented by treating the surface of the nanochannel with a specific polymer solution to be positively charged.

In addition, there is a method of combining photopolymerization and surface modification.

After a positively charged polymer gel is injected into the microchannel, a laser is locally irradiated to cause a photochemical reaction.

As a result, there is a method in which a micro-region irradiated with the laser is cured to implement an anion exchange membrane.

However, the methods have a problem in that the device manufacturing process is complicated, and the application to the micrometer scale is limited due to low scalability.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a porous anion exchange membrane and a manufacturing method of manufacturing the porous anion exchange membrane in a simple process.

An exemplary embodiment of the present invention provides a porous anion exchange membrane including a porous polymer support; and an anion-permselective material supported in the porous polymer support, in which the porous anion exchange membrane may have a micro-nano composite pore structure including microscale pores and nanoscale pores.

The nanoscale pores may have an average diameter in the range of 0.1 nm to 30 nm, and the microscale pores may have an average diameter in the range of 1 μm to 1000 μm.

The anion-permselective material may be a polymer synthesized through bromination in a polymer backbone, and brominated poly(2,6-dimethyl 1,4-phenylene)oxide (Br-PPO).

The porous polymer support may be a thermoplastic resin and consist of at least one selected from a polyester resin, a polypropylene resin, and an acryl resin.

Another exemplary embodiment of the present invention provides a manufacturing method of a porous anion exchange membrane including steps of: preparing a mixture by mixing an anion-permselective material solution, a polymer resin, and inorganic salt particles; pouring and heating the mixture into a mold to prepare a molded body; and removing an inorganic salt in the molded body.

The inorganic salt particles may be at least one selected from sodium chloride, potassium chloride, magnesium chloride and calcium chloride, and an average particle diameter D50 of the particles may be in the range of 1 μm to 1000 μm, specifically 1 μm to 500 μm, more specifically 1 μm to 400 μm.

The polymer resin may be a thermoplastic resin, and at least one selected from a polyester resin, a polypropylene resin, and an acryl resin.

The polymer resin and the anion-permselective material solution may be mixed in the range of 0:6 to 6:6 by volume.

In addition, the anion-permselective material solution may be obtained by reacting a solution obtained by dissolving a polymer synthesized through bromination in a polymer backbone in n-methyl-2 pyrrolidone with a trimethylamine solution.

The polymer synthesized through bromination in the polymer backbone may be brominated poly(2,6-dimethyl 1,4-phenylene)oxide.

The concentration of the anion-permselective material solution may be in the range of 10 wt % to 20 wt %.

The pouring and heating of the mixture into the mold to prepare the molded body may be performed in a temperature range of 70° C. to 80° C., and the removing of the inorganic salt in the molded body may be removing the inorganic salt through washing.

According to an embodiment of the present invention, the anion exchange membrane has an effect of allowing the flow of both ions and fluid due to the characteristic of the porous structure.

In addition, since the positively charged sample treatment device is easily implemented through the exchange membrane according to the present invention, there is an effect of greatly improving accessibility in related fields.

The manufacturing method of the anion exchange membrane according to the present invention has an effect capable of being easily manufactured in desired size and shape based on a casting method.

Unlike commercial anion exchange membranes, the anion exchange membrane according to the present invention is compatible with positively charged sample treatment devices of various scales, and its application is very simple, thereby greatly simplifying the device manufacturing process.

### BRIEF DESCRIPTION OF THE DRAWINGS

FIG. 1 is a schematic diagram illustrating a manufacturing process of a porous anion exchange membrane according to an exemplary embodiment.

FIG. 2 is a flowchart illustrating a manufacturing process of a porous anion exchange membrane according to an exemplary embodiment.

FIG. 3 illustrates (a) an image of a porous anion exchange membrane and (b) an SEM image and (c) a TEM image thereof according to an exemplary embodiment.

FIG. 4 illustrates a schematic diagram of a structural change of a porous anion exchange membrane in a manufacturing method according to the presence or absence of a polymer resin according to an exemplary embodiment.

FIG. 5 illustrates SEM images of porous anion exchange membranes according to Comparative Example 1 and Examples 1 to 4.

FIG. 6 illustrates TEM images of the porous anion exchange membranes according to Examples 1 to 4.

FIG. 7 illustrates a nanopore size distribution graph of the porous anion exchange membranes according to Examples 1 to 4.

FIG. 8 illustrates SEM images of porous anion exchange membranes with various micropore sizes according to an exemplary embodiment.

FIG. 9 illustrates a schematic diagram of an operating mechanism of a concentrating device to which the porous anion exchange membrane according to an exemplary embodiment is applied.

FIG. 10 illustrates fluorescent photographs for confirming electrochemical characteristics of the porous anion exchange membrane according to an exemplary embodiment.

FIG. 11 illustrates a current-voltage response graph of the porous anion exchange membrane according to an exemplary embodiment.

FIG. 12 illustrates a schematic diagram of a positively charged sample concentration device to which the porous anion exchange membrane according to an exemplary embodiment is applied.

FIG. 13 illustrates photographs of results of a concentration performance test for fluorescent particles according to an exemplary embodiment.

FIG. 14 illustrates a graph showing results of a concentration performance test for fluorescent particles according to an exemplary embodiment.

FIG. 15 illustrates photographs of results of a concentration performance test for protein particles according to an exemplary embodiment.

FIG. 16 illustrates a graph showing results of a concentration performance test for protein particles according to an exemplary embodiment.

### DETAILED DESCRIPTION OF THE EMBODIMENTS

The terms used herein are only for the purpose of describing specific exemplary embodiments and are not intended to limit the present invention.

The singular forms used herein include plural forms, unless expressly indicated to the contrary thereto.

The “comprising” used herein means embodying a specific feature, region, integer, step, operation, element and/or component, and the existence or addition of other specific features, regions, integers, steps, operations, elements, and/or components is not excluded.

Unless defined otherwise, all terms including technical and scientific terms used herein have the same meaning as commonly understood by those skilled in the art to which the present invention pertains.

Commonly used predefined terms are further interpreted as having a meaning consistent with the relevant technical literature and the present invention, and are not to be construed as ideal or very formal meanings unless defined otherwise.

In addition, unless otherwise specified, % means wt %, and 1 ppm is 0.0001 wt %.

Terms such as first, second and third are used to describe various parts, components, regions, layers and/or sections, but are not limited thereto.

These terms are used only to distinguish one part, component, region, layer or section from the other part, component, region, layer or section.

Accordingly, a first component, part, region, layer or section to be described below may be referred to as a second component, part, region, layer or section without departing from the scope of the present invention.

Hereinafter, exemplary embodiments of the present invention will be described in detail.

However, the exemplary embodiments are illustrative as examples, and accordingly, the present invention is not limited thereto, and the present invention will be only defined by the scope of the claims to be described below.

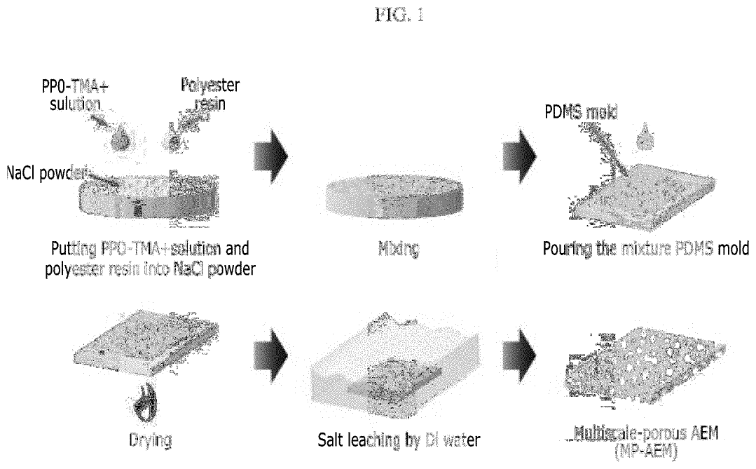

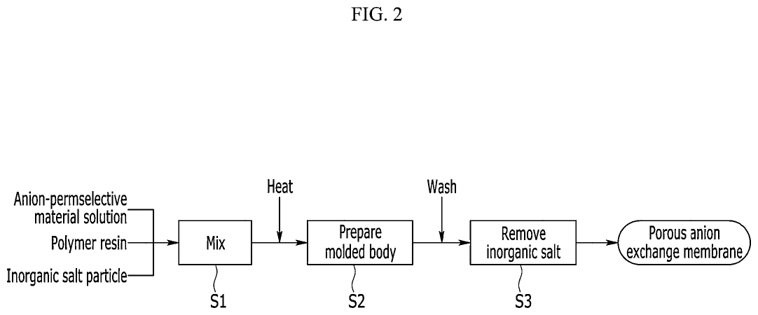

FIG. 1 is a schematic diagram illustrating a manufacturing process of a porous anion exchange membrane according to an exemplary embodiment, and FIG. 2 is a flowchart illustrating a manufacturing process of a porous anion exchange membrane according to an exemplary embodiment.

Referring to FIGS. 1 and 2, the porous anion exchange membrane according to the exemplary embodiment of the present invention may be manufactured by preparing a mixture by mixing an anion-permselective material solution, a polymer resin, and inorganic salt particles, pouring and heating the mixture into a mold to prepare a molded body, and removing an inorganic salt in the molded body.

The anion-permselective material solution may be obtained by dissolving a polymer synthesized through bromination in a polymer backbone in n-methyl-2 pyrrolidone and then reacting the result product with a trimethylamine solution.

Specifically, the anion-permselective material solution may be obtained by dissolving brominated poly(2,6-dimethyl 1,4-phenylene)oxide (Br-PPO) is dissolved in n-methyl-2 pyrrolidone and then reacting the result product with a trimethylamine solution.

In addition, the organic solvent may be dissolved in quaternary benzyl ammonium groups to be obtained.

In this case, the concentration of the anion-permselective material in the anion-permselective material solution may be in the range of 10 wt % to 20 wt %.

When the concentration of the anion-permselective material is lower than the above range, it is difficult for the prepared anion exchange membrane to function normally, and when the concentration thereof is higher than the above range, there is a problem that the quality of the prepared anion exchange membrane is deteriorated due to poor dissolution.

The inorganic salt particle may be a material that may be removed by washing with water, and specifically, may be an alkali metal or alkaline earth metal salt having high solubility in water, and more specifically, at least one selected from sodium chloride, potassium chloride, magnesium chloride or calcium chloride.

Meanwhile, an average particle diameter (D50) of the inorganic salt particles may be specifically in the range of 1 μm to 1000 μm, specifically in the range of 1 μm to 500 μm, more specifically in the range of 1 μm to 400 μm.

When the average particle diameter (D50) of the inorganic salt particles is within the above range, it is advantageous to obtain a desired pore size of the porous anion exchange membrane in the present invention.

Meanwhile, the polymer resin may be a thermoplastic resin, specifically, may be at least one selected from a polyester resin, a polypropylene resin, and an acrylic resin.

In addition, the polymer resin and the anion-permselective material solution may be mixed in the range of 0:6 to 6:6 by volume.

When the mixing ratio is within the above range, the mechanical strength of the prepared porous anion exchange membrane may be obtained.

In addition, when the polymer resin content exceeds the above range, the concentration of the anion-permselective material in the prepared porous anion exchange membrane is low to cause a problem that it is difficult to perform an electrochemical effect as the anion exchange membrane.

The anion-permselective material solution and the inorganic particles may be mixed in the range of 1:1 to 1.5:1 by volume.

When the anion-permselective material solution and the inorganic particles are mixed within the above range, it is advantageous to obtain desired nanopores and micropores in the present invention.

Meanwhile, the preparing of the molded body by pouring and heating the mixture into the mold may be performed at a temperature range of 60° C. to 90° C., specifically 70° C. to 80° C.

When heating the mixture in the above temperature range, it is possible to effectively remove the organic solvent contained in the anion-permselective material solution, and it is advantageous to control the size of the nanopores.

The shape and size of the mold may be adjusted to control the shape and size of the porous anion exchange membrane.

In addition, the molded body may include a polymer resin, an anion-permselective material, and inorganic particles.

Accordingly, the inorganic particles are removed to form pores of the porous anion exchange membrane.

The inorganic particles may be removed through washing, and may be removed using ultrapure water.

The porous anion exchange membrane according to an exemplary embodiment of the present invention may include a porous polymer support and an anion-permselective material supported on the porous polymer support, and may have a micro-nano composite pore structure.

The micro-nano composite pore structure may include nanopores having a nanoscale diameter and micropores having a microscale diameter.

The average diameter of the nanopores may be in the range of 0.1 nm to 30 nm, specifically, in the range of 0.1 nm to 15 nm.

The average diameter of the micropores may be in the range of 1 μm to 1000 μm, specifically in the range of 1 μm to 500 μm, and more specifically in the range of 1 μm to 400 μm.

The anion-permselective material may be a polymer synthesized through bromination in a polymer backbone, and specifically, may be brominated poly(2,6-dimethyl 1,4-phenylene)oxide (Br-PPO).

In addition, the porous polymer support may be a thermoplastic resin, specifically, may consist of at least one selected from a polyester resin, a polypropylene resin, and an acrylic resin.

Hereinafter, Examples of the present invention will be described in detail.

However, Examples are illustrative as examples, and the present invention is not limited thereto, and the present invention can be only defined by the scope of claims to be described below.

### Example 1

A poly(2,6-dimethyl 1,4-phenylene)oxide solution with quaternary benzyl trimethylamine (PPO-TMA+) was applied to NaCl powder prepared by grinding.

The NaCl powder may have an average particle diameter of 3 mm or less, specifically 2 mm or less, and more specifically 1 mm or less.

Thereafter, a polyester resin to improve mechanical strength was further mixed to form a mixture.

After the mixture was stirred and mixed, the mixture was poured into a mold, and heated to a temperature range of 70° C. to 80° C. to remove fully the solvent in the PPO-TMA+ solution to form a molded product.

The molded product may be washed with ultrapure water to completely remove NaCl to prepare a porous anion exchange membrane.

Here, the polyester resin and the PPO-TMA+ solution were mixed in a ratio of 1:6 by mass.

### Examples 2 to 4

A porous anion exchange membrane was prepared in the same manner as in Example 1, except that the polyester resin and the PPO-TMA+ solution were mixed at 2:6, 3:6 and 6:6 by mass.

### Comparative Example 1

A porous anion exchange membrane was prepared in the same manner as in Example 1, except that the polyester resin and the PPO-TMA+ solution were mixed at 0:6 by mass.

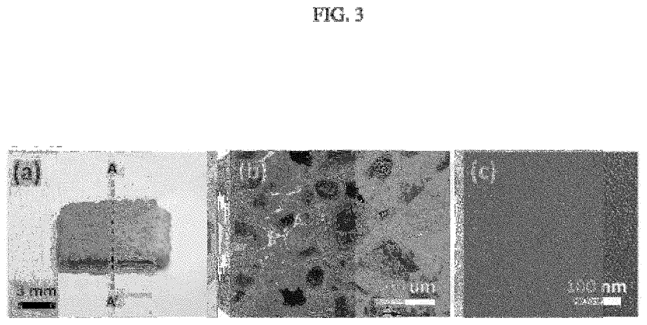

FIG. 3 illustrates (a) an image of a porous anion exchange membrane and (b) an SEM image and (c) a TEM image thereof according to an exemplary embodiment.

Referring to FIG. 3, as shown in (a), in the porous anion exchange membrane prepared according to the manufacturing method of the porous anion exchange membrane, it can be confirmed that as salts are leached and removed, micro-scale pores (micropores) are formed at the corresponding positions.

It can be confirmed that a polymer resin forms a polymer resin support by heating (b), and nanoscale pores (nanopores) are formed (c) by heating and removing the anion-permselective material solution.

Accordingly, since the prepared porous anion exchange membrane includes both nanopores and micropores, both ions and fluid flows can be allowed.

In addition, the prepared porous anion exchange membrane is compatible with a positively charged sample treatment device of various scales (micrometer scale to macro scale) to be manufactured in desired size and shape based on a casting technique of pouring the mixture into the mold.

In addition, there is an advantage of greatly simplifying the manufacturing process of the device as the porous anion exchange membrane can be applied to the device through simple mounting on the existing device.

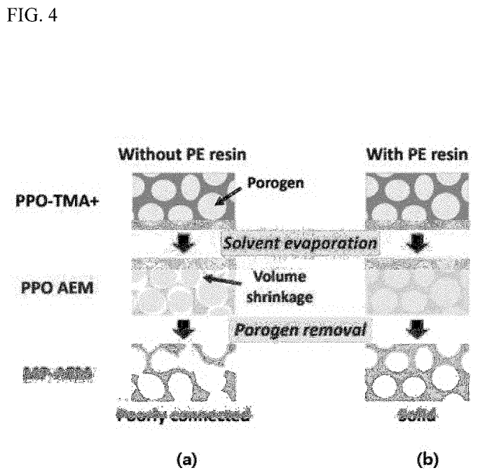

FIG. 4 illustrates a schematic diagram of a structural change of a porous anion exchange membrane manufactured by a manufacturing method according to the presence or absence of a polymer resin according to an exemplary embodiment.

Referring to FIG. 4, the polymer resin forms a polymer resin support that determines the shape and size of the porous anion exchange membrane.

Meanwhile, the organic solvent included in the anion-permselective material solution may be mixed in the range of about 80 wt % to 90 wt %, specifically 85 wt %.

The organic solvent is removed in the manufacturing process of the porous anion exchange membrane, so that the volume can be reduced.

In the case of (a) using only the anion-permselective material (PPO-TMA+) solution without a polymer resin, it can be confirmed that the support structure is not dense but loose due to the rapid volume reduction of the mixture.

In the case of (b) with the polymer resin, it has been confirmed to form a polymer support having a relatively dense structure, and it can be confirmed to minimize the overall volume reduction by complementing the volume reduction of the mixture due to the evaporation of the organic solvent with the polymer resin.

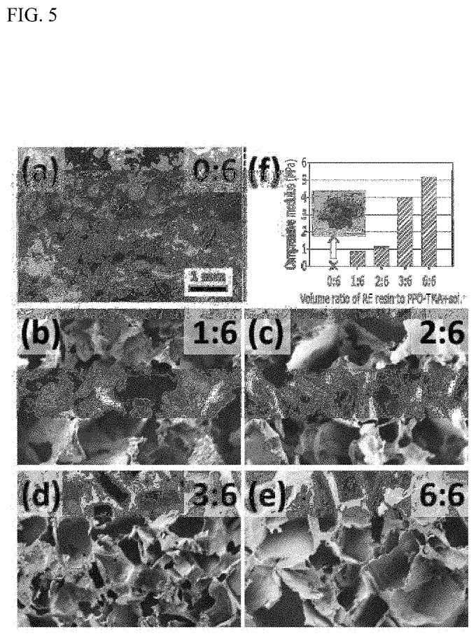

FIG. 5 illustrates SEM images of porous anion exchange membranes according to Comparative Example 1 and Examples 1 to 4.

Referring to FIG. 5, it can be confirmed that the mechanical strength of the porous anion exchange membrane is changed according to the polymer resin content.

As described above, Examples 1 to 4 are porous anion exchange membranes prepared by mixing the polymer resin and the anion-permselective material solution at 1:6, 2:6, 3:6 and 6:6 by mass, and Comparative Example 1 is a porous anion exchange membrane without the polymer resin.

As illustrated in FIG. 5(a), in case of Comparative Example 1, the vulnerable porous anion exchange membrane was formed with a vulnerable structure destroyed under a very small pressure.

As illustrated in FIGS. 5(b) to 5(e), it can be confirmed that as the content of the polymer resin according to Examples 1 to 4 is changed, in the prepared porous anion exchange membrane, the support structure is changed.

First, in the case of FIG. 5(b) as Example 1, it can be confirmed that a support structure was formed based on a thin plate-shaped unit, and has a predetermined mechanical strength as compared with the case of Comparative Example 1(a).

Even in the case of FIG. 5(c) as Example 2, it can be confirmed that a support structure was formed based on a thin plate-shaped unit, and a connection state between units was good as compared with the case of Example 1(b).

In the case of Example 3(d), a support structure of a thick wall structure was formed, rather than a thin plate-shaped unit.

In addition, in the case of Example 4(e), it was confirmed that a support structure of a thicker wall structure was formed.

FIG. 5(f) shows a mechanical strength graph of a porous anion exchange membrane according to a polymer resin content.

In the case of the Comparative Example 1(a), the structure was weak enough not to measure the mechanical strength itself, and as the polymer resin content increased, the mechanical strength of the manufactured porous anion exchange membrane was increased.

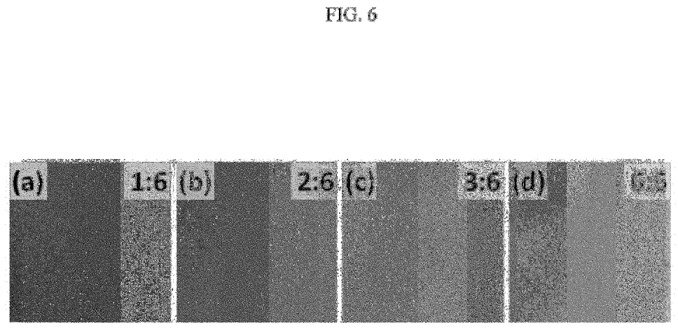

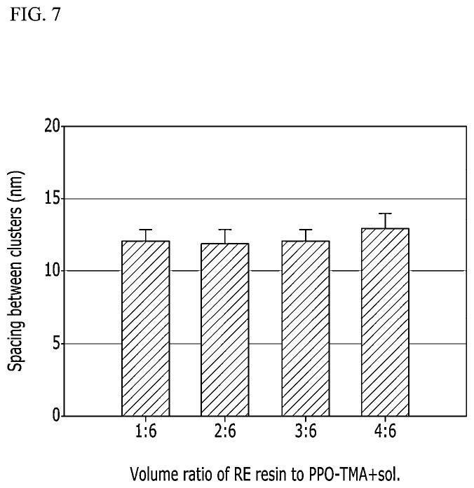

FIG. 6 illustrates TEM images of the porous anion exchange membranes according to Examples 1 to 4, and FIG. 7 illustrates a nanopore size distribution graph of the porous anion exchange membranes according to Examples 1 to 4.

From a nanopore distribution transmission electron microscope (TEM) analysis result of the support structure of the prepared porous anion exchange membrane of FIG. 6, it can be confirmed that as the polymer resin content increases, the distribution density of unit clusters (black dots) gradually decreases, and a white region (an increase in brightness) increases.

When it is considered that the unit cluster is derived from the anion-permselective material solution, it is determined that an increase in brightness is caused by a change in a mixing ratio of the polymer resin and the anion-permselective material solution in the porous anion exchange membrane.

In addition, as illustrated in FIG. 7, it was shown that an average nanopore size distribution of the porous anion exchange membrane was almost similar in all conditions.

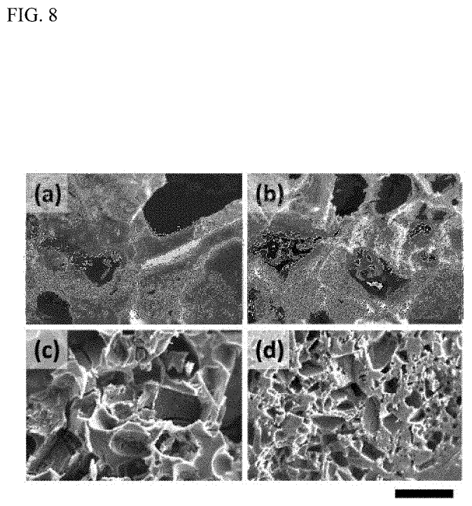

FIG. 8 illustrates SEM images of porous anion exchange membranes with various micropore sizes according to an exemplary embodiment.

FIG. 8(a) is a SEM image of a porous anion exchange membrane having an average micropore size of 400 μm or more, FIG. 8(b) is a SEM image of a porous anion exchange membrane having an average micropore size in the range of 250 μm to 400 μm, FIG. 8(c) is a SEM image of a porous anion exchange membrane having an average micropore size in the range of 125 μm to 250 μm, and FIG. 8(d) is a SEM image of a porous anion exchange membrane having an average micropore size of 125 μm or less.

When the size of the micropores increases at the same porosity, a synthetic fluid resistance in a direction passing through the porous anion exchange membrane decreases so that the fluid flow becomes smoother, but the amount of ion leakage through the micropores increases, so that the amount of effective ions moving through the nanopores decreases.

On the contrary, when the size of the micropores is decreased, the fluid resistance increases, but the effective ion flow increases, so that the electrical performance of the exchange membrane is increased.

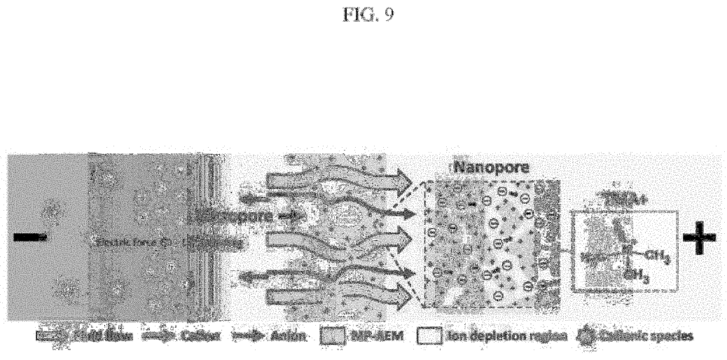

FIG. 9 illustrates a schematic diagram of the operating mechanism of the concentrating device to which the porous anion exchange membrane according to an exemplary embodiment is applied.

Referring to FIG. 9, the porous anion exchange membrane according to an exemplary embodiment of the present invention may be used in a concentration device of a positively charged sample.

When an electric field is applied to both ends of a fluid channel into which the porous anion exchange membrane is inserted, due to a non-uniform flow of ions in the exchange membrane with anion selectivity, an ‘ion concentration region’ with a very high ion concentration and an ‘ion depletion region’ with a very low ion concentration are formed at both ends of the exchange membrane.

In the case of the anion exchange membrane, the ion depletion region is formed on the surface (left side) of a cathode side of the exchange membrane, and since ions serving as a medium of an electric flow hardly exist in the ion depletion region, the ion depletion region serves as a very large electrical resistance element.

As a result, most of the electric field applied to the system is concentrated in the ion depletion region, and positively charged particles approaching the ion depletion region receive an electric force in the cathode direction.

The porous anion exchange membrane may have micropores to allow the fluid flow in a direction passing through the porous anion exchange membrane.

Accordingly, as illustrated in FIG. 9, the flow of the fluid may be applied in a direction parallel to the direction of the electric field.

In this situation, an electric force and a fluid drag force are applied to positively charged particles in the fluid approaching the ion depletion region formed near the exchange membrane, and the two forces are applied exactly in an opposite direction.

As a result, the particles stop at the point where the velocity components due to the two forces become the same as each other, and a particle concentration region (concentration band) is formed at the corresponding point.

Accordingly, by using the porous anion exchange membrane according to an exemplary embodiment, not only the particles can be concentrated even in a simple one-way channel, but also the size of the exchange membrane can be flexibly adjusted even when the scale of the channel is changed, so that it is possible to be applied to channels of various scales.

In addition, unlike existing anion-permselective materials that require a very complex synthesis process, there is an advantage of implementing the device through simple insertion.

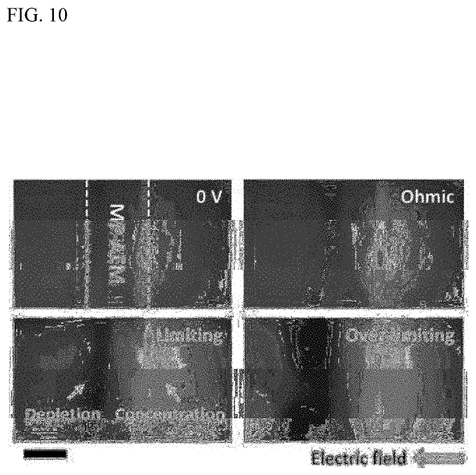

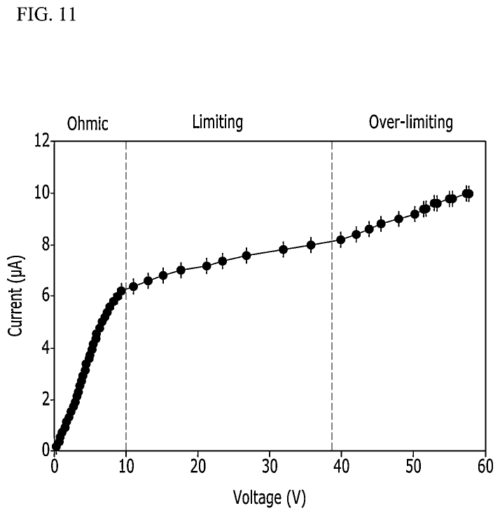

FIG. 10 illustrates fluorescent photographs for confirming electrochemical characteristics of the porous anion exchange membrane according to an exemplary embodiment, and FIG. 11 illustrates a current-voltage response graph of the porous anion exchange membrane according to an exemplary embodiment.

Referring to FIGS. 10 and 11, in the case of a current-voltage response of the porous anion exchange membrane according to an exemplary embodiment, as a voltage to be applied is increased, the current-voltage response is divided into an Ohmic section according to the Ohm's law, a limiting section where as the ion depletion region is expanded, the resistive element becomes very large, which limits the flow of current, and an over-limiting section where the current flow is restarted due to electrical convection.

Therefore, it can be confirmed that through the result of confirming the current-voltage response of the exchange membrane of the present invention, the exchange membrane normally functions as an ion exchange membrane.

### Preparation Example 1

A porous anion exchange membrane according to an exemplary embodiment was applied to manufacture a positively charged sample concentration device.

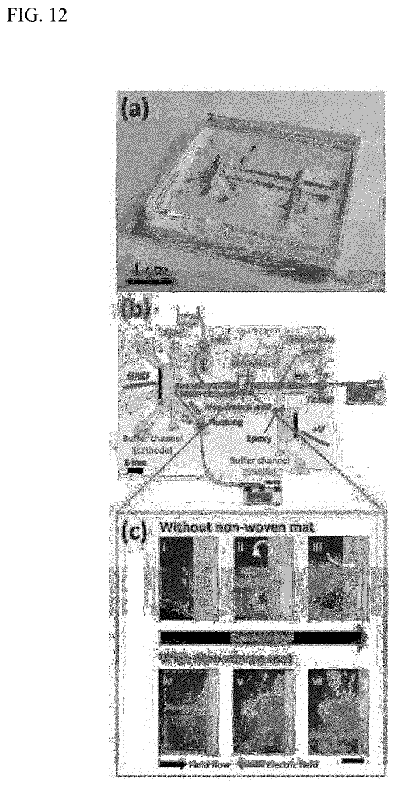

FIG. 12 illustrates a schematic diagram of a positively charged sample concentration device to which the porous anion exchange membrane according to an exemplary embodiment is applied.

Referring to FIG. 12, a support of the concentration device was prepared using a transparent elastomer, polydimethylsiloxane (PDMS) for fluorescence analysis.

The channel structure of the device support was formed using an embossed mold manufactured through 3D printing, and components (porous anion exchange membrane and electrodes) of the device were inserted into each slot formed with the channel structure.

A fluid flow of the device was controlled using a syringe pump, and an electric field was applied through a DC power supply.

The porous anion exchange membrane is located in the middle of a main channel.

By the principle (balance of speed) described above, the positively charged particles are concentrated in the vicinity of the ion depletion region in front of the exchange membrane.

On the left side of the exchange membrane, a micro-fiber structure (nonwoven mat) is installed to suppress a convection phenomenon (electrical convection) of the ion depletion region.

In general, in the micro-scale channel, a stable ion depletion region is induced without electrical convection, but when the scale is increased to millimeters or more, active electrical convection occurs so that the efficient concentration of the sample is impossible (FIG. 12(c)).

Since the main channel of the scale of several millimeters was used in the device, it was required to suppress the electric convection for efficient sample concentration.

When the nonwoven fabric is installed in the channel, due to the micropore distribution of the nonwoven fabric, one wide channel is converted into a structure in which numerous microchannels are connected to each other in parallel.

For this reason, the electrical convection phenomenon is suppressed by the microchannel parallel structure to form a stable ion depletion region in the wide channel, and as a result, a stable sample concentration region is formed (FIG. 12(c)).

### Experimental Example 1

A concentration experiment was performed by supplying cationic fluorescent particles and positively charged protein particles using the charged sample concentration device manufactured according to Preparation Example 1.

In the case of the fluorescent particles, concentration was performed by supplying the initial sample concentration of 100 nM, 1 μM, 10 μM and 100 μM.

The intensity and flow rate of the electric field are properly adjusted so that the sample concentration region may be formed on the nonwoven fabric.

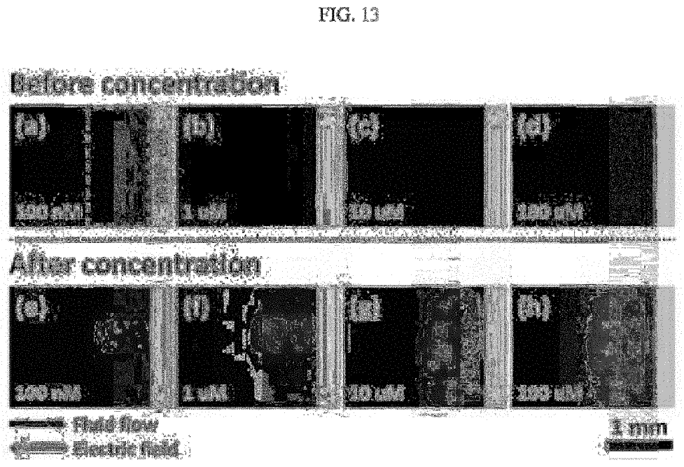

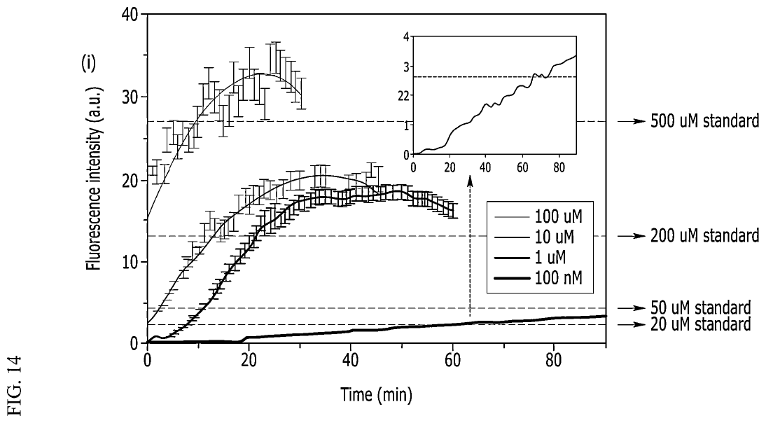

FIG. 13 illustrates photographs of results of a concentration performance test for fluorescent particles according to an exemplary embodiment, and FIG. 14 illustrates a graph showing results of a concentration performance test for fluorescent particles according to an exemplary embodiment.

Referring to FIGS. 13 and 14, in the case of fluorescent particles, concentration was performed at the initial sample concentration of 100 nM, 1 μM, 10 μM, and 100 μM.

The intensity and flow rate of the electric field were properly adjusted so that the sample concentration region may be formed on the nonwoven fabric.

The formation pattern of the concentrated region before and after concentration was differently shown for each initial sample concentration condition.

As the initial sample concentration was increased, the concentration region was gradually expanded, and under the highest initial sample concentration conditions, it was confirmed that the concentration region was formed throughout the nonwoven fabric.

The maximum concentration rate (maximum particle concentration (number) after concentration to initial particle concentration (number) in a specified region) was about 500 under the initial sample concentration condition of 100 nM.

That is, in the specified region, one particle before concentration was included and 500 particles after concentration were included.

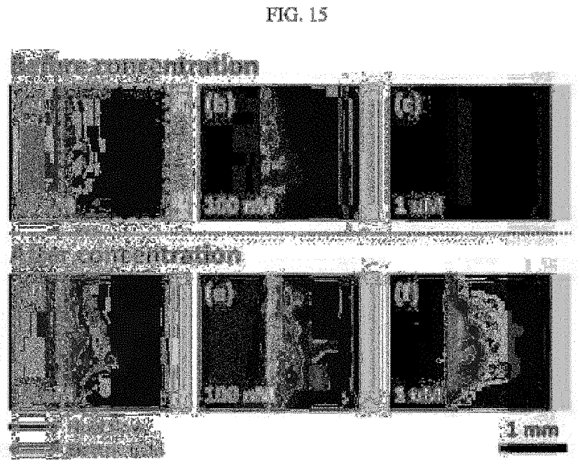

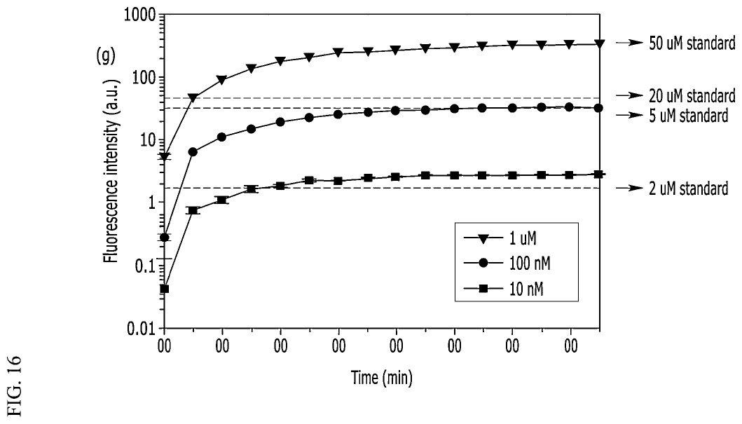

FIG. 15 illustrates photographs of results of a concentration performance test for protein particles according to an exemplary embodiment, and FIG. 16 illustrates a graph showing results of a concentration performance test for protein particles according to an exemplary embodiment.

Referring to FIGS. 15 and 16, the initial sample concentration conditions of protein particles were set to 10 nM, 100 nM, and 1 μM.

A concentration region of the protein particles was narrower and thinner than that of the fluorescent particles, which is caused by a difference between the particle size and diffusivity.

The protein particles having a relatively large particle size and low diffusivity are concentrated in a local region.

Even in the case of the protein particles, the maximum concentration rate was shown at 10 nM, the lowest initial sample concentration condition, and the value there of was about 250.

The present invention can be manufactured in various different forms, not limited to the above embodiments, and it will be appreciated to those skilled in the present invention that the present invention may be implemented in other specific forms without changing the technical idea or essential features of the present invention.

Therefore, it should be appreciated that the aforementioned exemplary embodiments are illustrative in all aspects and are not restricted.

While this invention has been described in connection with what is presently considered to be practical exemplary embodiments, it is to be understood that the invention is not limited to the disclosed embodiments.

On the contrary, it is intended to cover various modifications and equivalent arrangements included within the spirit and scope of the appended claims.

What is claimed is:

1. A porous anion exchange membrane comprising:
a porous polymer support; and
an anion-permselective material supported in the porous polymer support,
wherein the porous anion exchange membrane has a micro-nano composite pore structure including microscale pores and nanoscale pores.

2. The porous anion exchange membrane of claim 1, wherein:
the nanoscale pores have an average diameter in the range of 0.1 nm to 30 nm.

3. The porous anion exchange membrane of claim 1, wherein:
the microscale pores have an average diameter in the range of 1 μm to 1000 μm.

4. The porous anion exchange membrane of claim 1, wherein:
the anion-permselective material is a polymer synthesized through bromination in a polymer backbone.

5. The porous anion exchange membrane of claim 4, wherein:
the polymer synthesized through the bromination in the polymer backbone is brominated poly(2,6-dimethyl 1,4-phenylene)oxide.

6. The porous anion exchange membrane of claim 1, wherein:
the porous polymer support is a thermoplastic resin.

7. The porous anion exchange membrane of claim 6, wherein:
the porous polymer support consists of at least one selected from a polyester resin, a polypropylene resin, and an acryl resin.

8. A manufacturing method of a porous anion exchange membrane comprising steps of:
preparing a mixture by mixing an anion-permselective material solution, a polymer resin, and inorganic salt particles;
pouring and heating the mixture into a mold to prepare a molded body; and
removing an inorganic salt in the molded body.

9. The manufacturing method of the porous anion exchange membrane of claim 8, wherein:
an average particle diameter D50 of the inorganic salt particles is in the range of 1 μm to 1000 μm.

10. The manufacturing method of the porous anion exchange membrane of claim 8, wherein:
the inorganic salt particles are at least one selected from sodium chloride, potassium chloride, magnesium chloride and calcium chloride.

11. The manufacturing method of the porous anion exchange membrane of claim 8, wherein:
the polymer resin is a thermoplastic resin.

12. The manufacturing method of the porous anion exchange membrane of claim 11, wherein:
the thermoplastic resin is at least one selected from a polyester resin, a polypropylene resin, and an acryl resin.

13. The manufacturing method of the porous anion exchange membrane of claim 8, wherein:
the polymer resin and the anion-permselective material solution are mixed in the range of 0:6 to 6:6 by volume.

14. The manufacturing method of the porous anion exchange membrane of claim 8, wherein:
the anion-permselective material solution is obtained by
reacting a solution obtained by dissolving a polymer synthesized through bromination in a polymer backbone in n-methyl-2 pyrrolidone with a trimethylamine solution.

15. The manufacturing method of the porous anion exchange membrane of claim 14, wherein:
the polymer synthesized through bromination in the polymer backbone is brominated poly(2,6-dimethyl 1,4-phenylene)oxide.

16. The manufacturing method of the porous anion exchange membrane of claim 15, wherein:
the concentration of the anion-permselective material solution is in the range of 10 wt % to 20 wt %.

17. The manufacturing method of the porous anion exchange membrane of claim 8, wherein:
the pouring and heating of the mixture into the mold to prepare the molded body is performed in a temperature range of 70° C. to 80° C.

18. The manufacturing method of the porous anion exchange membrane of claim 8, wherein:
the removing of the inorganic salt in the molded body is removing the inorganic salt through washing.
